(19) United States
(12) Patent Application Publication
(10) Pub. No.: US 2007/0037505 A1
(43) Pub. Date: Feb. 15, 2007

(54) Automobile vent airflow controller

(76) Inventors: Rong-Shuang Wang, Egg Harbor Township, NJ (US); Chung-Shing Wang, Boston, MA (US)

Correspondence Address: Rong Shuang Wang, 609 Shires Way, Egg Harbor Township, NJ, 08234, US

(21) Appl. No.: 11/200,141

(22) Filed: Aug. 10, 2005

(51) Int. Cl. B60H 1/24

(52) U.S. Cl. 454/162

(57) ABSTRACT

New automobile vent airflow controllers are invented. In addition to the capability of changing the airflow direction as the conventional controllers have, these controllers can also adjustably diffuse the airflow. For most of conventional controllers, in addition to other parts, like the taps/dials and vent surround, each controller has two sets of linked shutter plates, one on upper level and one on lower level. Unlike the conventional controllers, these controllers have a total of three to four sets of linked shutter plates arranged in two levels. The orientation of each set of shutter plates can be independently controlled.

### BACKGROUND OF THE INVENTION

Almost all the existing automobile vent airflow controllers have a basic configuration. For each controller, it has a tap or dials, a set of linked upper level shutter plates and a set of linked lower level shutter plates. The tap or dials are used for controlling the orientations of the upper and lower level linked shutter plates. The orientations determine the airflow direction. The configuration is simple and the control is effective. However, the airflow coming out of the vent is like an air column which has a small cross section area. When the air conditioner is used, because the area is small, the user, driver or front seat passenger, cannot enjoy the airflow aiming at his/her face very long. To cool off the whole car space, the noise coming out of the vent becomes another problem. To solve these problems, a way is to diffuse the air column. The diffused airflow retains the same amount of cold from the vent, can evenly cover a larger area of the user's body, and has a lower speed.

### BRIEF SUMMARY OF THE INVENTION

This invention is for automobile vent airflow control. For each vent, in addition to the control taps/dials and vent surround, it has in total of three or four sets of linked shutter plates arranged in two levels. Each set of the shutter plates can be independently controlled.

One objective of the invention is to have automobile vent airflow controllers which can adjustably diffuse the airflow in addition to the conventional airflow direction control function.

Another objective of the invention is to have an automobile vent airflow controllers which can use conventional procedures for controlling airflow direction.

A further objective of the invention is to have automobile vent airflow controllers which can carry out airflow diffusion function without much complicating the existing airflow control mechanisms.

### BRIEF DESCRIPTION OF THE DRAWING

FIG. 1 is the top view of the controller without showing its supporting surround.

FIG. 2 is the A-A cross section view of the controller shown in FIG. 1.

FIG. 3 is the B-B cross section view of the controller shown in FIG. 1.

### DETAILED DESCRIPTION OF THE INVENTION

The configuration of an automobile vent airflow controller which has four sets of linked shutter plates is described as follows.

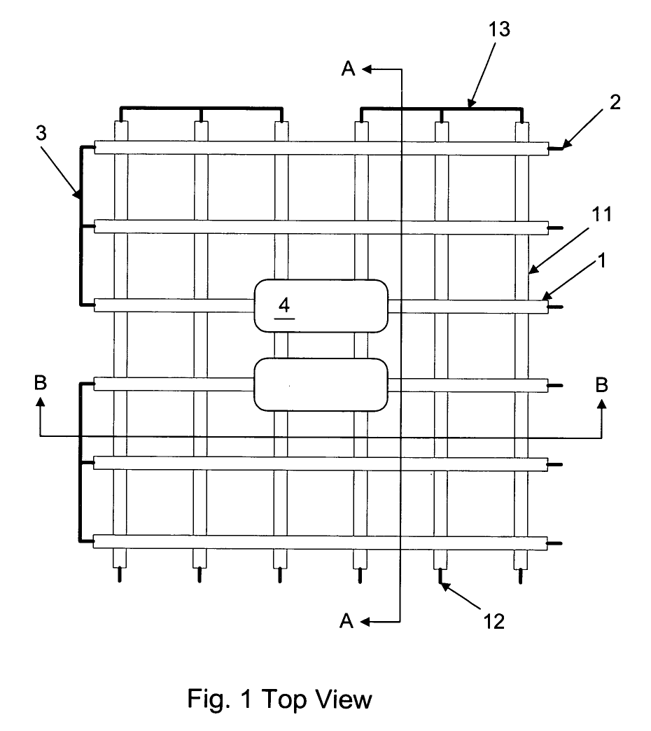

FIG. 1 is the top view of the controller without showing its supporting surround. There are upper level shutter plates [1] and lower level shutter plates [11]. At an end of each upper level shutter plate [1] there is an axle [2], and the plate [1] can rotate about the axle [2]. Likewise, at an end of each lower level shutter plate [11] there is an axle [12], and the plate [11] can rotate about the axle [12]. The upper level shutter plates [1] are in two sets. Each set has a linkage [3] linking the plates [1] in the set such that when one plate [1] rotates, the rest of the plates [1] in the set also rotate accordingly. Likewise, the lower level shutter plates [11] are in two sets. Each set has a linkage [13] linking the plates [11] in the set such that when one plate [11] rotates, the rest of the plates [11] in the set also rotate accordingly. Each set, upper or lower level, can rotate independently. The airflow passes through the lower level shutter plates [11] before passing through the upper level shutter plates [1]. The airflow between the upper level plates [1] in a set is guided by the orientation of the plates [1] of the set. A tap [4] is loosely installed on an upper level plate [1] of a set. A second tap [4] is loosely installed on an upper level plate [1] of a second set. The taps [4] are for the upper and lower level plates orientation control, however, they are shown here for illustrative purpose only and by no means restrictive because other means, like dials by the side of the vent, can be used to control the set rotations, besides, the control can also be applied to a linkage.

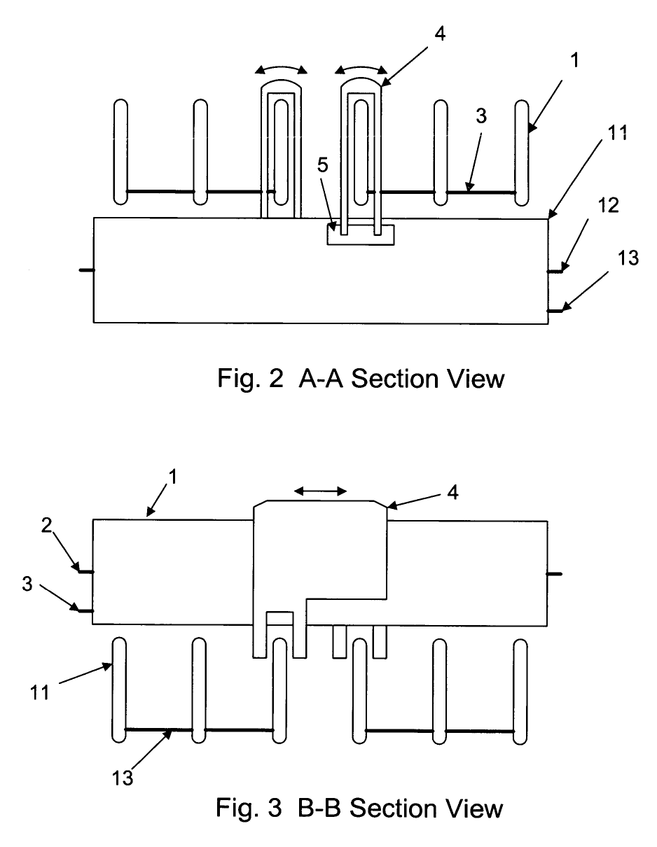

FIG. 2 is the A-A cross section view of the controller shown in FIG. 1. At an end of a lower level shutter plate [11] there is an axle [12]. The axles [12] are pivotally supported by the surround. Each lower level shutter plate [11] can rotate about its two axles [ 12]. The tap [4] installed on an upper level shutter plate [1] of a set is also loosely engaged to one of the lower level shutter plates [11] of a set. The tap [4] can be pushed on its broadsides. The push and the linkage [3] will cause all the upper level shutter plates [1] of the set to rotate accordingly. A hole [5] allows independent rotation between the upper level shutter plates [1] and lower level shutter plates [11]. A second tap [4] is installed on an upper level shutter plate [1] of the second set and is loosely engaged to a lower level shutter plate [11] of a set. The second tap [4] can be pushed on its broadside. The push and the linkage [3] will cause all the upper level shutter plates [1] of the second set to rotate accordingly. Because the orientations of the two sets of the upper shutter plates [1] are independent, when the upper edges of the two sets of the plates [1] are pushed apart, the airflows passing through the two sets of plates [1] can be split in two directions and the airflow is diffused. The degree of diffusion depends on the angle between the two sets of shutter plates [1]. A conventional automobile vent airflow controller has all its upper level shutter plates linked together as one set, and all the plates have the same orientation, therefore the airflow passing through the plates is in one direction and is not diffused.

FIG. 3 is the B-B cross section view of the controller shown in FIG. 1. At an end of an upper level shutter plate [1] there is an axle [2]. The axles [2] are pivotally supported by the surround. Each upper level shutter plate [1] can rotate about its two axles [2]. Because each set of the upper level plates [1] are linked by its linkage [3], when one of the plates [1] rotates, the rest of the plates [1] in the set will rotate accordingly. The lower portion of the tap [4] is loosely engaged to one of the lower level shutter plates [11] of a set. When the tap [4] slides along the upper plate [1], it will push the engaged lower level plate [11] and a linkage [13] will rotate each of the rest of the lower level plates [11] in the set. The airflow between the lower level plates [11] in the set is guided by the orientation of the plates [11] of the set. Likewise, the second tap [4] can rotate the second set of the lower level plate [11]. Because the orientations of the two sets of the lower shutter plates [11] are independent, the airflows passing through the two sets of plates [11] can be split in two directions and the airflow is diffused. Because the upper level shutter plates are orthogonal to the lower level shutter plates, the two sets of lower level shutter plates [11] and the two sets of the upper level shutter plates [1] together can diffuse the airflows in four directions. Because the orientations of each set of the plates [1] and [11] are adjustable by the taps [4], the degree of diffusion can be controlled. An existing automobile vent airflow controller has all its upper level shutter plates linked together as one set and all its lower level shutter plates linked as one set, the airflow after passing through the two levels of plates is in one direction and not diffused.

When the two taps [4] are pushed and slid together, all the upper level shutter plates [1] will act like one set, and all the lower level shutter plates [11] will act like one set. In this condition, the controller can perform the same function like a conventional vent airflow controller and the airflow is not diffused. In this description, four sets of the shutter plates are needed to diffuse the airflow in four directions. To have the airflow diffused only in two directions, three sets of the shutter plates can serve the purpose, i.e. two for the upper level and one for the lower level, or one for the upper level and two for the lower level. For either case, two taps are needed for the control.

The above description shows these automobile vent airflow controllers can adjustably diffuse the airflow, and retains all the operation and function of the existing automobile vent airflow controller.

We claim:

1. An automobile vent airflow controller comprising two sets of upper level shutter plates and two sets of lower level shutter plates; each plate having an axle at one end of the plate, the axle being pivotally supported by a surround, the plate being able to rotate about the axle, the plates in each set being linked together such that all the plates in the set can rotate to a same orientation when a plate in the set rotates due to a push by a control means, the rotation of a set of the shutter plates being independent of that of another set of the shutter plates.

2. An automobile vent airflow controller according to claim 1 comprising two sets of upper level shutter plates and one set of lower level shutter plates.

3. An automobile vent airflow controller according to claim 1 comprising one set of upper level shutter plates and two sets of lower level shutter plates.
